(19) United States
(12) Patent Application Publication
(10) Pub. No.: US 2021/0051284 A1
(43) Pub. Date: Feb. 18, 2021

(54) IMAGING SYSTEMS AND METHODS FOR PERFORMING ANALOG DOMAIN REGIONAL PIXEL LEVEL FEATURE EXTRACTION

(71) Applicant: SEMICONDUCTOR COMPONENTS INDUSTRIES, LLC, Phoenix, AZ (US)

(72) Inventors: Roger PANICACCI, Los Gatos, CA (US); Tomas GEURTS, Haasrode (BE)

(73) Assignee: SEMICONDUCTOR COMPONENTS INDUSTRIES, LLC, Phoenix, AZ (US)

(21) Appl. No.: 16/821,767

(22) Filed: Mar. 17, 2020

Related U.S. Application Data
(60) Provisional application No. 62/885,387, filed on Aug. 12, 2019.

(51) Int. Cl. H04N 5/378; H04N 5/341

(52) U.S. Cl. CPC H04N 5/378; H04N 5/341

(57) ABSTRACT

Imaging circuitry may include circuits for implementing charge mode feature extraction in the analog domain. The imaging circuitry may include pixels configured to generate pixel values. The pixel values may then be weighted using adjustable weighting circuits to generate corresponding weighted pixel values. The weighted pixels values may then be combined to obtain an output neuron voltage for at least one layer in a neural network. The output neuron voltage may be stored in idle pixels, may be combined with other weighted pixel values, and may be otherwise manipulated prior to being processed in the digital domain. Performing feature extraction in the analog domain for each layer of results in the neural network saves power and area by avoiding the need to move data around to conventional digital memories.

This application claims the benefit of provisional patent application No. 62/885,387, filed Aug. 12, 2019, which is hereby incorporated by reference herein in its entirety.

### BACKGROUND

This relates generally to imaging devices, and more particularly, to imaging devices having image sensor pixels on wafers that are stacked on other image readout/signal processing wafers.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Imaging systems may implement convolutional neural networks (CNN) to perform feature extraction (i.e., to detect one or more objects, shapes, edges, or other scene information in an image). Feature extraction can be performed in a smaller region of interest (ROI) having a lower resolution than the entire pixel array. Typically, the analog pixel values in the lower resolution ROI are read out, digitized, and stored for subsequent processing for feature extraction and convolution steps.

### BRIEF DESCRIPTION OF THE DRAWINGS

FIG. 1 is a diagram of an illustrative electronic device having an image sensor and processing circuitry for capturing images using an array of image pixels in accordance with some embodiments.

FIG. 2 is a diagram of an illustrated stacked imaging system in accordance with an embodiment.

FIG. 3 is a diagram of an illustrative image sensor array coupled to digital processing circuits and analog processing circuits in accordance with an embodiment.

FIG. 4A is a diagram showing how an image pixel may be connected to a particular region of interest (ROI) via various switch networks in accordance with an embodiment.

FIG. 4B is a diagram of an illustrative ROI unit cell in accordance with an embodiment.

FIG. 4C is a diagram showing how an ROI may be connected via diagonal routing lines in accordance with an embodiment.

FIG. 5 is a diagram showing how a convolution kernel may be applied to an ROI to extract features in accordance with an embodiment.

FIG. 6A is diagram of a pixel readout structure for supporting an illustrative charge mode operation in accordance with an embodiment.

FIG. 6B is a diagram of a pixel readout structure for supporting a dark pixel option to allow non-destructive processing of multiple kernels in accordance with an embodiment.

FIG. 6C is a flow chart of illustrative steps for operating the pixel circuitry of FIG. 6B in accordance with an embodiment.

FIG. 7A is a diagram illustrating one suitable implementation of a charge mode feature extraction circuit that uses adjustable capacitors in accordance with an embodiment.

FIG. 7B is a flow chart of illustrative steps for operating the charge mode feature extraction circuit shown in FIG. 7A in accordance with an embodiment.

FIG. 7C is a timing diagram showing relevant signals for operating the circuitry shown in FIG. 7A in accordance with an embodiment.

FIG. 7D is a diagram showing how intermediate analog results may be temporarily stored in idle pixels in accordance with an embodiment.

FIG. 8A is a diagram illustrating another suitable implementation of a charge mode feature extraction circuit that uses adjustable resistors in accordance with an embodiment.

FIG. 8B is a diagram illustrating one suitable implementation of a sum/difference charge integrator block in accordance with an embodiment.

FIG. 8C is a diagram showing how selectively adjustable current mirror circuitry may be used to provide different weights in accordance with an embodiment.

FIG. 9A is a diagram illustrating yet another suitable implementation of a charge mode feature extraction circuit that uses adjustable resistors coupled to a switched-cap integrator in accordance with an embodiment.

FIG. 9B is a flow chart of illustrative steps for operating the charge mode feature extraction circuit shown in FIG. 9A in accordance with an embodiment.

FIG. 10 is a diagram illustrating yet another suitable implementation of a charge mode feature extraction circuit that uses differential amplifier circuitry to compute the difference between the values of different groups of pixels in accordance with an embodiment.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

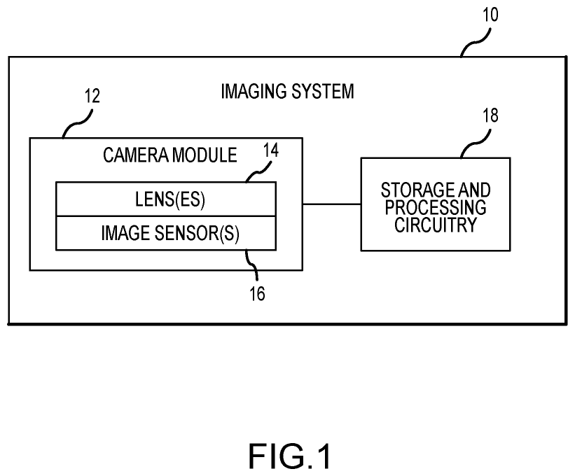

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

In accordance with an embodiment, groups of pixel values in the analog domain may be processed to extract features associated with objects in a scene. The pixel information is not being digitized to a low resolution region of interest. The feature information extracted from a pixel array can be processed in multiple steps of a convolutional neural network (as an example) using this analog implementation to identify scene information for the system, which can then be used to decide whether or not to output pixel information at a higher resolution in that region of the scene.

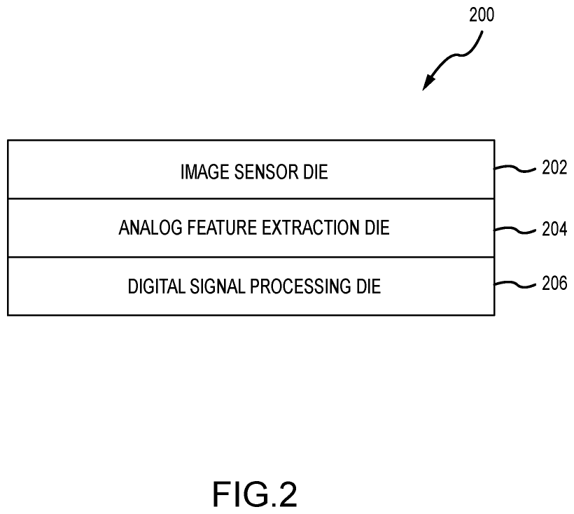

Die stacking may be leveraged to allow the pixel array to connect to corresponding region of interest (ROI) processors to enable efficient analog domain feature extraction (e.g., to detect object features of interest and temporal changes for areas of the array that are not being read out at full resolution through the normal digital signal processing path). Extracted features may be temporarily stored in the analog domain, which can be used to check for changes in feature values over time and to detect changes in key features related to objects in the scene. FIG. 2 is a diagram of an illustrated stacked imaging system 200. As shown in FIG. 2, system 200 may include an image sensor die 202 as the top die, a digital signal processor die 206 as the bottom die, and an analog feature extraction die 204 that is stacked vertically between top die 202 and bottom die 206. The array of image sensor pixels reside within the top image sensor die 202; the normal digital readout circuits reside within the bottom die 206; and the analog domain feature extraction circuitry are formed within the middle die 204. If desired, other ways of stacking the various imager dies may also be used.

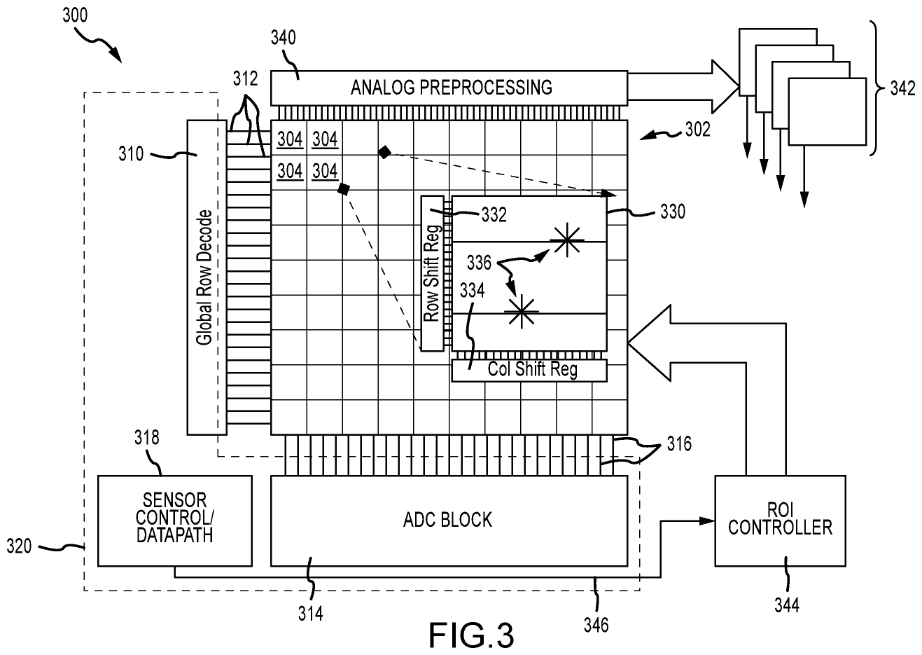

FIG. 3 is a diagram of an illustrative image sensor array 302 coupled to digital processing circuits and analog processing circuits. The digital signal processing circuits are delineated by dotted box 320, which include a global row decoder 310 configured to drive all the pixel rows within array 302 via row control lines 312, an analog-to-digital converter (ADC) block 314 configured to receive pixels values via each pixel column through the normal readout paths 316, and a sensor controller 318. These digital signal processing circuits 320 may reside within the bottom die 206 (see FIG. 2).

The image pixel array 302 may be formed on the top image sensor die 202. Pixel array 302 may be organized into groups sometimes referred to as “tiles” 304. Each tile 304 may, for example, include 256×256 image sensor pixels. This tile size is merely illustrative. In general, each tile 304 may have a square shape, a rectangular shape, or an irregular shape of any suitable dimension (i.e., tile 304 may include any suitable number of pixels).

Each tile 304 may correspond to a respective “region of interest” (ROI) for performing feature extraction. A separate ROI processor 330 may be formed in the analog die 204 below each tile 304. Each ROI processor 330 may include a row shifter register 332, a column shift register 336, and row control and switch matrix circuitry for selectively combining the values from multiple neighboring pixels, as represented by converging lines 336. Signals read out from each ROI processor 330 may be fed to analog processing and multiplexing circuit 340 and provided to circuits 342. Circuits 342 may include analog filters, comparators, high-speed ADC arrays, etc. Sensor control 318 may send signals to ROI controller 344, which controls how the pixels are read out via the ROI processors 330. For example, ROI controller 344 may optionally control pixel reset, pixel charge transfer, pixel row select, pixel dual conversion gain mode, a global readout path enable signal, a local readout path enable signal, switches for determining analog readout direction, ROI shutter control, etc. Circuits 330, 340, 342, and 344 may all be formed within the analog die 204.

An imaging system configured in this way may support content aware sensing. The analog readout path supports rapid scanning for shape/feature detection, non-destructive intensity thresholding, temporal events, and may also use on-board vision smart components to process shapes. The high-speed ROI readout path can also allow for digital accumulation and burst readout without impact to the normal frame readout. This content aware sensor architecture reads out different regions at varying resolutions (spatial, temporal, bit depth) based on the importance of that part of the scene. Smart sensors are used to monitor activity/events in regions of the image that are not read out at full resolution to determine when to wake up that region for higher resolution processing. The analog feature extraction supports monitoring of activity in those particular regions of interest without going into the digital domain. Since the analog feature extraction does not require processing through an ADC, a substantial amount of power can be saved.

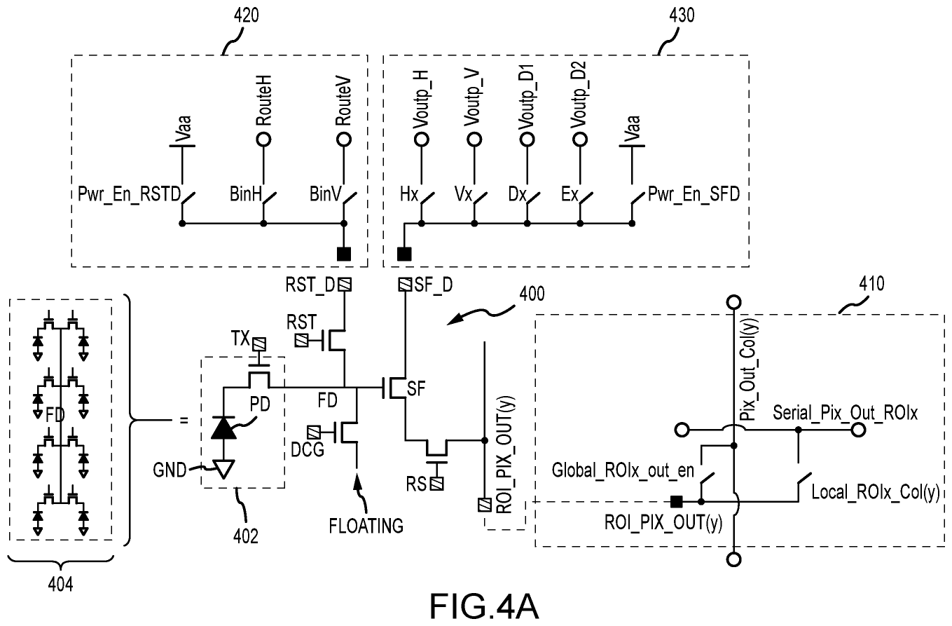

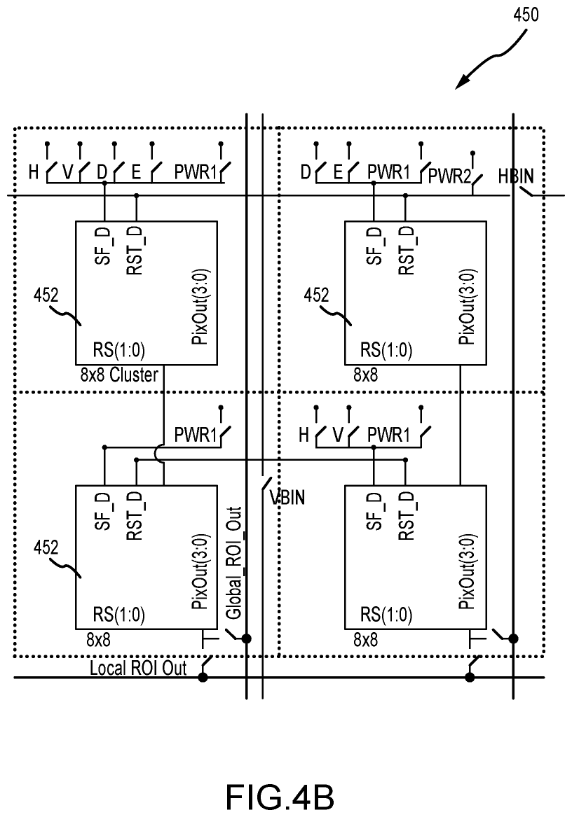

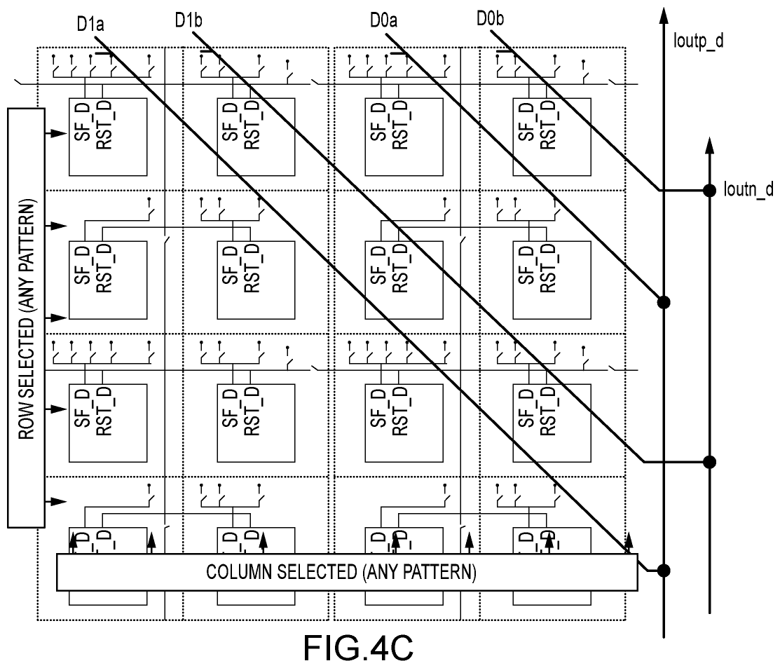

FIG. 4A is a diagram showing how an image pixel may be connected to a particular region of interest (ROI) via various switch networks. As shown in FIG. 4A, an image sensor pixel such as pixel 400 may include a photodiode PD coupled to a floating diffusion node FD via a charge transfer transistor, a reset transistor coupled between the FD node and a reset drain node RST_D, a dual conversion gain (DCG) transistor having a first terminal connected to the FD node and a second terminal that is electrically floating, a source follower transistor with a drain node SF_D, a gate terminal connected to the FD node, and a source node coupled to the ROI pixel output line via a corresponding row select transistor. Portion 402 of pixel 404 may alternatively include multiple photodiodes that share a single floating diffusion node, as shown by configuration 404.

In the example of FIG. 4A, each reset drain node RST_D within an 8×8 pixel cluster may be coupled to a group of reset drain switches 420. This is merely illustrative. In general, a pixel cluster that share switches 420 may have any suitable size and dimension. Switches 420 may include a reset drain power enable switch that selectively connects RST_D to positive power supply voltage Vaa, a horizontal binning switch BinH that selectively connects RST_D to a corresponding horizontal routing line RouteH, a vertical binning switch BinV that selectively connects RST_D to a corresponding vertical routing line RouteV, etc. Switch network 420 configured in this way enables connection to the power supply, binning charge from other pixels, focal plane charge processing.

Each source follower drain node SF_D within the pixel cluster may also be coupled to a group of SF drain switches 430. Switch network 430 may include a SF drain power enable switch Pwr_En_SFD that selectively connects SF_D to power supply voltage Vaa, switch Hx that selectively connects SF_D to a horizontal line Voutp_H, switch Vx that selectively connects SF_D to a vertical line Voutp_V, switch Dx that selectively connects SF_D to a first diagonal line Voutp_D1, switch Ex that selectively connects SF_D to a second diagonal line Voutp_D2, etc. Switches 430 configured in this way enables the steering of current from multiple pixel source followers to allow for summing/differencing to detect shapes and edges and connection to a variable power supply.

Each pixel output line ROI_PIX_OUT(y) within the pixel cluster may also be coupled to a group of pixel output switches 410. Switch network 410 may include a first switch Global_ROIx_out_en for selectively connecting the pixel output line to a global column output bus Pix_Out_Col(y) and a second local switch Local_ROIx_Col(y) for selectively connecting the pixel output line to a local ROI serial output bus Serial_Pix_Out_ROIx that can be shared between different columns. Configured in this way, switches 410 connects each pixel output from the ROI to one of the standard global output buses for readout, to a serial readout bus to form the circuit used to detect shapes/edges, to a high speed local readout signal chain, or a variable power supply.

FIG. 4B is a diagram of an illustrative ROI unit cell 450. In the example of FIG. 4B, each ROI unit cell 450 may include four 8×8 pixel clusters 452 that share the various switch networks described in connection with FIG. 4A. In the example of FIG. 4B, each cluster 452 may have a different number of SF_D switches. For example, the top left cluster may be coupled to five SF_D switches while the top right cluster may only be coupled to three SF_D switches. This is merely illustrative. If desired, each cluster 452 may be coupled to any suitable number of SF_D switches. In the example of FIG. 4B, the various clusters 452 may be coupled to shared horizontal and vertical binning switches. Moreover, the clusters along each column may be coupled to a respective global output bus, whereas all of the clusters in unit cell 450 may be coupled to a common local ROI serial output bus.

FIG. 4C is a diagram showing how an ROI may be connected via diagonal routing lines. Signals read out via a first group of diagonal readout lines may produce a first output current Ioutp_d, whereas signals read out via a second group of diagonal readout lines may produce a second output current Ioutn_d. These output currents may be read out via the local ROI SF_D switches (e.g., switches 420 in FIG. 4A) or via the local ROI RST_D switches (e.g., switches 430 in FIG. 4A). Different diagonal lines may be enabled to detect different shapes (e.g., diagonal edges).

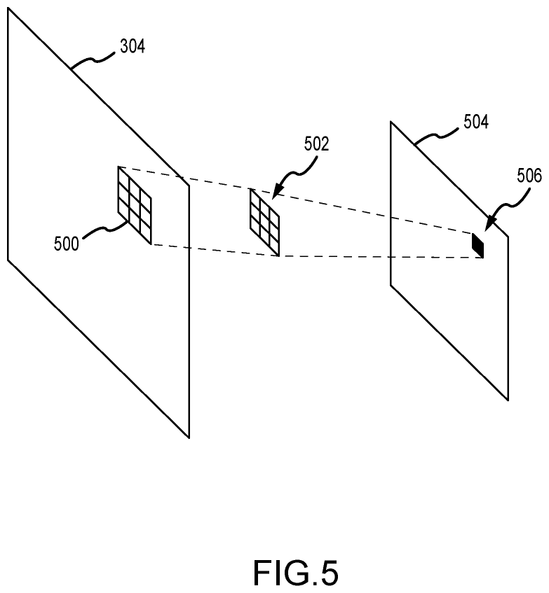

FIG. 5 is a diagram showing how a convolution kernel 502 may be applied to a tile 304 or ROI to extract features 506. Convolution kernel 502 may include a collection of weights. Convolution kernel 502 may be applied to a corresponding window 500 sliding across ROI 304. In the example of FIG. 5, kernel 502 is shown as a 3×3 matrix. This is, however, merely illustrative. Kernel 502 may be a 5×5 array of weights or a matrix of any suitable size or dimension. Each kernel window 500 performs an analog multiply accumulate (MAC) operation to obtain a resulting convolution feature 506. Multiple convolution features 506 may be combined into a feature map 504 that is the same size or optionally smaller than tile 304. Other ways of generating CNN layers may also be implemented.

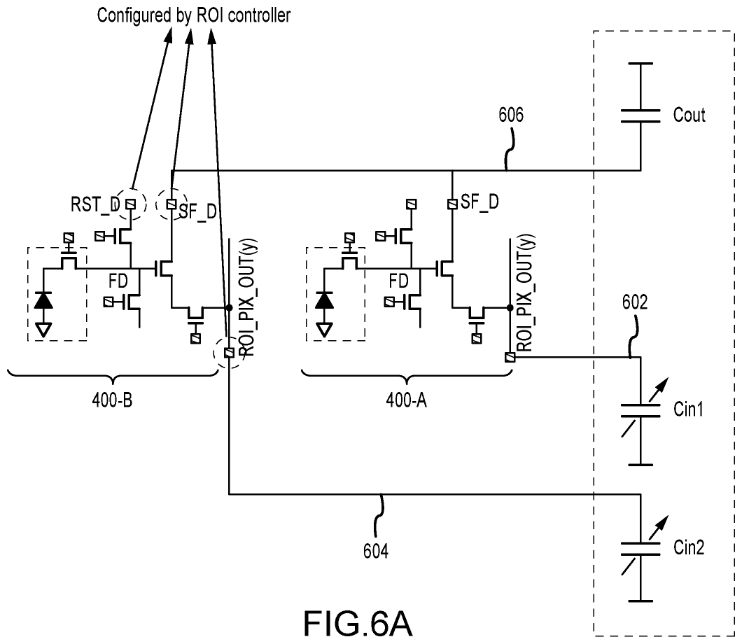

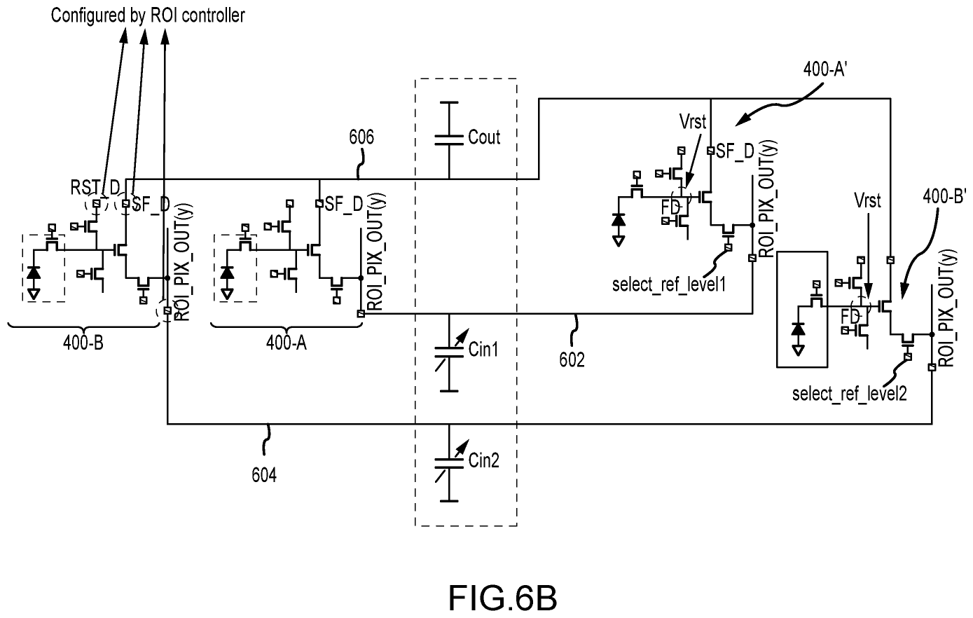

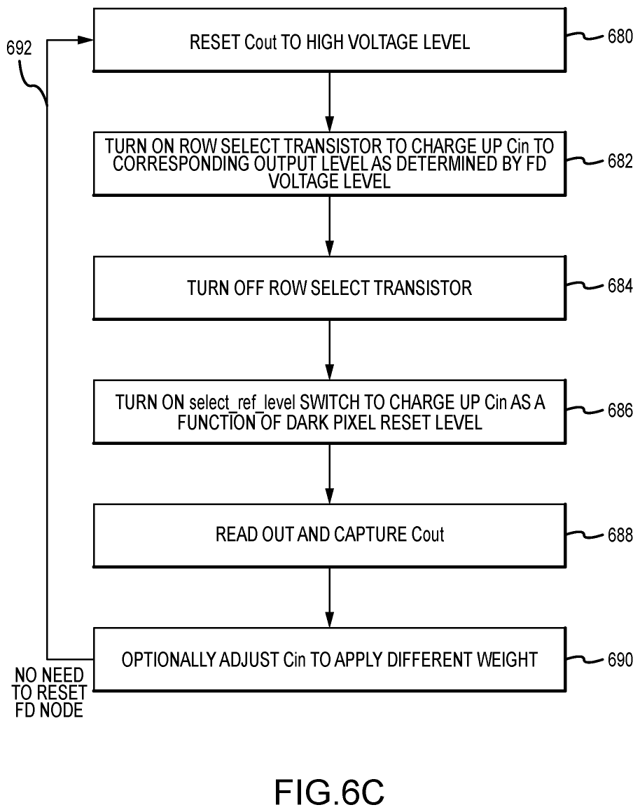

FIG. 6A is diagram of a pixel readout structure for supporting an illustrative charge mode operation in accordance with an embodiment. The analog level feature extraction may occur without a change in the image pixel circuit and is enabled by a ROI controller that configures connections into the pixel array (see, e.g., switches 410, 420, and 430 in FIG. 4A). As shown in FIG. 6A, a first pixel 400-A may be configured to output a first pixel value to a first variable capacitor Cin1 via a first local/serial readout bus 602, whereas a second pixel 400-B may be configured to output a second pixel value to a second variable capacitor Cin2 via a second local/serial readout bus 604. The SF_D nodes of both pixels 400-A and 400-B may be coupled to a shared output capacitor Cout via path 606. Capacitor Cin1 weights the value of pixel 400-A for the kernel operation, whereas capacitor Cin2 weights the value of pixel 400-B for the kernel operation. The capacitance of capacitors Cin1 and Cin2 may be adjusted depending on the desired weighting needed by the kernel operation. Capacitors Cout, Cin1, and Cin2 may be formed at the periphery of each ROI processor 330 or at the periphery of the intermediate analog die (see FIG. 3).

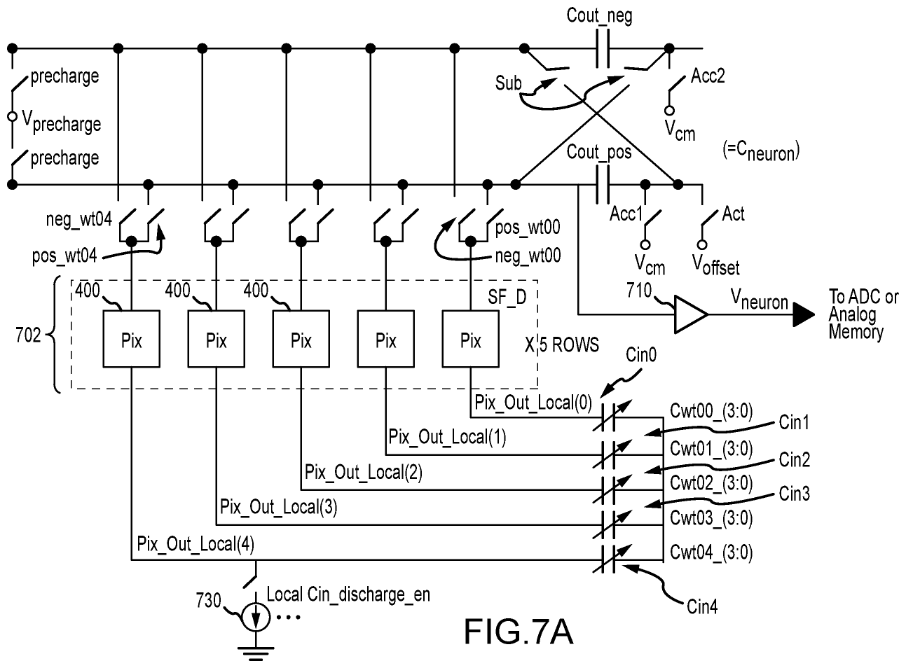

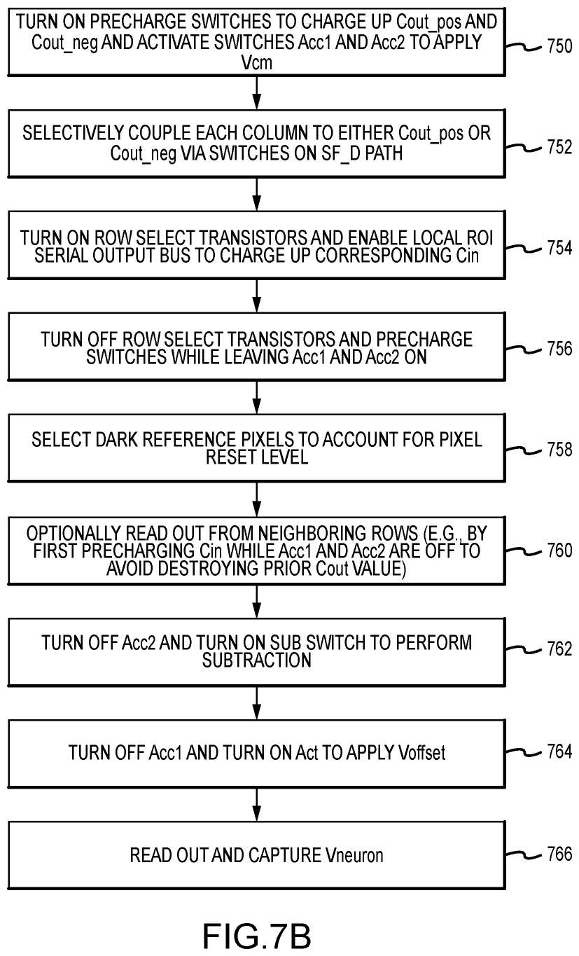

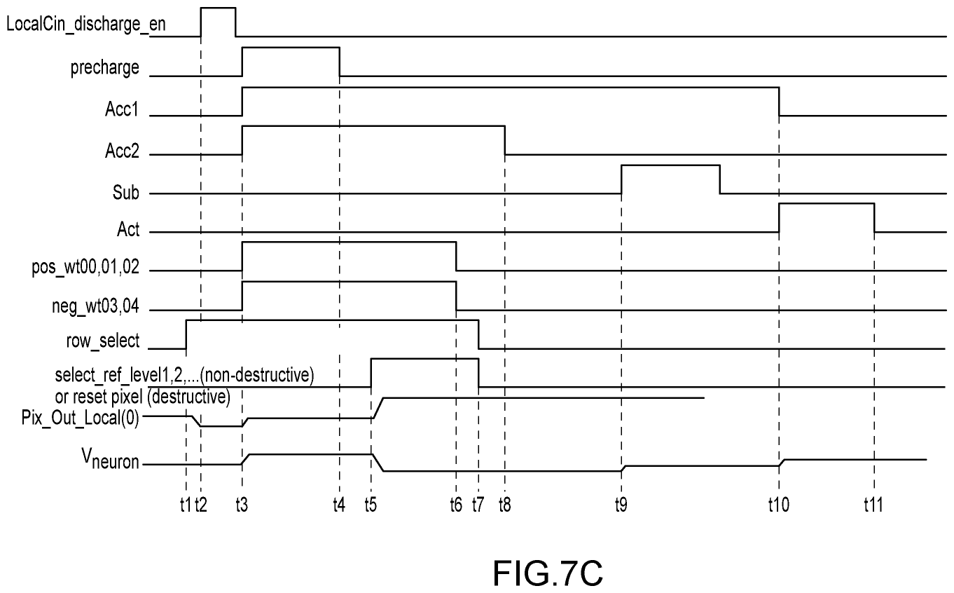

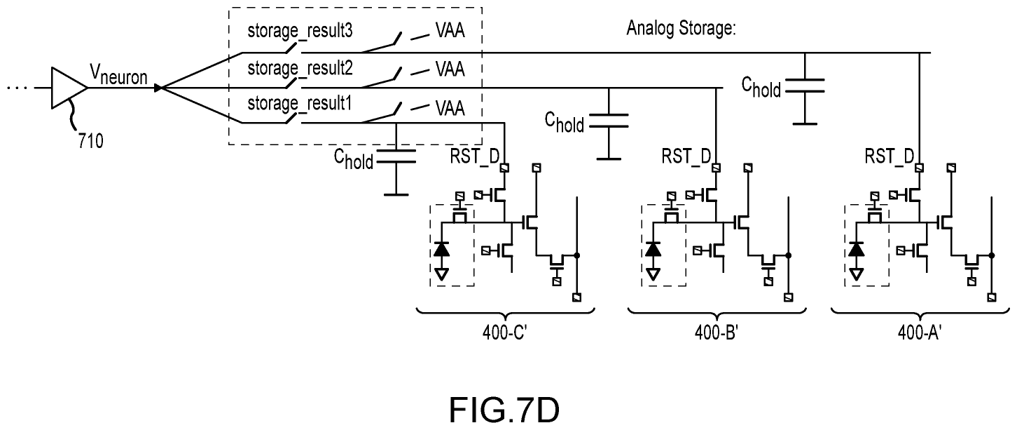

During charge mode operation, pixel signal stored on the floating diffusion node is assumed. Capacitor Cout may be precharged to a high voltage while capacitors Cin1 and Cin2 are charged up based on the associated FD voltages. The precharge to capacitor Cout may then be turned off and the FD nodes are reset. As a result, capacitor Cout will discharge by an amount proportional to the FD signal level multiplied by the Cin capacitor size connected to that pixel. The final weighted pixel values will be summed at Cout. If desired, negative weight coefficients (if needed) may be implemented using a second Cout capacitor and a crossbar switch (see, e.g., FIG. 7A). Activation of a neuron output (e.g., a convolution feature) is enabled by an offset applied to the Cout capacitor. If desired, non-linear clamping of negative values (“ReLU”) may be enabled by subsequent analog processing where the value is stored on the FD node and is limited to the pixel FD reset level. An analog value can then be stored back into the pixel array via the RST_D connection.

FIG. 6B is a diagram of a pixel readout structure for supporting a dark pixel option to allow non-destructive processing of multiple kernels. As shown in FIG. 6B, capacitor Cin1 may also be coupled to a first dark reference pixel via path 602, and capacitor Cin2 may also be coupled to a second dark reference pixel via path 604. These “dark” reference pixels may be separate optically black pixels. The SF_D terminal in both dark reference pixels may be connected to capacitor Cout via path 606. Instead of turning off the precharge to Cout and resetting the FD node, the precharge to Cout may be turned off while connecting Cin1, Cin2, and Cout to the dark reference pixels. Multiple dark pixels may be simultaneously connected in to the local/serial readout bus after charging Cin1/2 with pixels 400-A and 400-B. In another suitable arrangement, a single dark pixel may be serially connected to each local readout bus. In yet another suitable arrangement, a predetermined reference voltage may be supplied to the SF_D nodes using the intermediate analog die.

Each of the dark reference pixels should have their FD nodes reset to a predetermined reset voltage level. The reset transistor of these “black” reference pixels should be always turned on or pulsed periodically. This black pixel option allows setting of a global reset level during the weighted charge transfer time to Cout to allow re-use of that capacitor for multiple weight processing (of multiple kernels) and to allow non-destructive sensing of the FD node multiple times (for multiple kernels). In this case, the pixels only charge the Cin value to the initial pre-charge value, and then the global dark pixel connected to Cout and the pixel output line will charge up each Cin to the reset level. Dark reference pixels operated in this way may sometimes be referred to as dark pixel reference drivers. This may result in slightly elevated fixed pattern noise (FPN) due to threshold voltage variations at the source follower transistor, which is acceptable for applications with low bit resolution weights.

FIG. 6C is a flow chart of illustrative steps for operating the pixel circuitry shown in FIG. 6B. At step 680, capacitor Cout may be reset to a high voltage level. At step 682, the row select transistors may be turned on to charge up the corresponding Cin to a corresponding output level as determined by the associated floating diffusion node (e.g., the FD node of pixel 400-A may be used to charge up Cin1, whereas the FD node of pixel 400-B may be used to charge up Cin2).

At step 684, the row select transistors may be turned off. At step 686, the select_ref_level switches may be turned on further charge up the corresponding Cin as a function of the dark pixel reset level (e.g., the row select transistor of the first dark reference pixel may be turned on by asserting select_ref_level1 to charge up Cin1, whereas the row select transistor of the second dark reference pixel may be turned on by asserting select_ref_level2 to charge up Cin2). At step 688, the final Cout value (which should have decreased from the reset level whenever any one of the Cin's pull charge away from Cout) may be read out and captured. At step 690, the Cin capacitors may be optionally adjusted to apply a different weight without destroying the pixel values at the FD nodes. Processing may then loop back to step 680 as indicated by path 692 without overwriting or resetting the FD nodes.

FIG. 7A is a diagram illustrating one suitable implementation of a charge mode feature extraction circuit that uses adjustable capacitors. As shown in FIG. 7A, portion 702 may represent a kernel window with 5×5 pixels 400 (as an example). A first column of pixels in the window is coupled to a first adjustable capacitor bank Cin0 via a local ROI serial output bus Pix_Out_Local(0); a second column of pixels in the window is coupled to a second adjustable capacitor bank Cin1 via local ROI serial output bus Pix_Out_Local(1); a third column of pixels in the window is coupled to a third adjustable capacitor bank Cin2 via local ROI serial output bus Pix_Out_Local(2); and so on. The Cin at each of the serial output buses may be individually discharged using a corresponding pull-down switch coupled to a current sink 730 by selectively asserting a local Cin discharge enable signal LocalCin_discharge_en. These various capacitor banks may exhibit adjustable capacitance values that can be tuning using control bits Cwt0x_(3:0). There may be any suitable number of capacitance control bits to provide the desired level to tuning granularity.

The SF_D node of each pixel in each column of the kernel window 702 may be selectively coupled to a positive output capacitor Cout_pos via switches pos_wt and may be selectively coupled to a negative output capacitor Cout_neg via switches neg_wt. Capacitors Cout_pos and Cout_neg may be selectively precharged to voltage Vprecharge via a pair of precharge switches.

Capacitor Cout_pos may be selectively coupled to a common mode voltage Vcm via switch Acc1. Similarly, capacitor Cout_neg may be selectively coupled to the common mode voltage Vcm via switch Acc2. Offset voltage Voffset may be selectively applied only to capacitor Cout_pos via switch Act. Switches Sub may both be turned on to cross-couple capacitors Cout_pos and Cout_neg when it is desired to perform a differencing/subtraction operation. These various switches may be peripheral circuits on the intermediate analog die 204. Capacitor Cout_pos is connected to a buffer 710, which generates final output voltage Vneuron. Voltage Vneuron may be fed to an ADC, analog memory for temporary storage, or subsequent additional processing in the digital or analog domain to flag features.

Configured in this way, the circuitry of FIG. 7A may be used to perform weighting and summing for an array of analog pixel values without prior ADC conversion. The Vneuron output may be equal to (W*x+b), where W is the weight values, x is the pixel value, and b is the offset. The multiply accumulate (MAC) operation on the pixel values is achieved by utilizing capacitor ratios, where multiple results are summed together to generate the final neuron result. The analog storage of intermediate results is done by feeding the Vneuron back into the pixel array FD node in an idle region that is not being used for imaging at that time (as described in connection with FIG. 7D). Analog storage in the pixel array allows for the processing of more layers in a neuron network with weighting and activation functions (offset) using the FD storage node directly. Eventually, the output of the analog feature processing is converted to a digital value for additional processing to flag features to use in understanding the scene content. The output may also be used to flag temporal changes in dominating features that are correlated to objects of interest (e.g., to perform smart event sensing) by storing the results from previous feature extraction operations.

Exemplary steps for operating the circuitry of FIG. 7A are shown in the flow chart of FIG. 7B. Initially, the capacitor weight values may be set; the pixel rows may be connected to the local serial output buses; and the pixel signal is assumed to be present at the FD nodes. At step 750, the output capacitors Cout_pos and Cout_neg (which may be collectively referred to as Cneuron) are precharged by turning on the precharge switches while switches Acc1 and Acc2 are activated to apply Vcm. Thereafter, the precharge switches may be turned off and Cneuron should be charged at the precharge level.

At step 752, each pixel column may be selectively coupled to either Cout_pos or Cout_neg via corresponding switches on the SF_D path. At step 754, the row select transistors may be turned on, which enables the local ROI serial output buses to charge up the corresponding Cin capacitors. At step 756, the row select transistors and the precharge switches may be turned off while switches Acc1 and Acc2 remain on.

At step 758, the dark references pixels may be selected (e.g., by turning on switches select_ref_level in FIG. 6B) to account for the pixel reset level to pull up Cneuron. Alternatively, the FD nodes may be reset. At step 760, neighboring image pixels may be read out (e.g., by first precharging the Cin capacitors while switches Acc1 and Acc2 are turned off to avoid destroying the prior Cneuron value).

At step 762, switch Acc2 is turned off and switch Sub can be turned on to perform subtraction (e.g., to remove the contribution of Cout_neg from Cout_pos). At step 764, switch Acc1 is turned off and switch Act is turned on to apply offset voltage Voffset. At step 766, a final Vneuron value may be output by buffer 710 and subsequently captured. These steps and the voltage level of the various relevant signals are illustrated in the timing diagram of FIG. 7C.

At time t1, a given row select signal may be asserted to select a row for readout (or to select multiple rows in parallel or to support parallel generation of weighted pixel values, if desired). At time t2, a local Cin discharge enable signal may be pulsed high to temporarily discharge the Cin capacitors. At time t3, the precharge, Acc1, Acc2, pos_wt, and neg_wt switches are all turned on to begin charging up Cin. In the example of FIG. 7C, columns 0, 1, and 2 are positively weighted (as indicated by the fact that switches pos_wt00/01/02 are activated) while columns 3 and 4 are negatively weighted (as indicated by the fact that switches neg_wt03/04 are activated). During this time, the corresponding local serial output bus may charge up to the voltage of the floating diffusion node minus the threshold voltage of the source follower transistor (i.e., V_{FD0}-V_{th,SF}). At time t4, the precharge transistor is turned off.

At time t5, the dark reference pixels may be selected to reset the serial output bus, which pulls charge away from and discharges Cout as seen by the drop in output voltage Vneuron. As described above, using dark reference pixels to perform reset implements non-destructive reset sampling, whereas simply resetting the pixel (i.e., the FD node) itself would implement destructive reset sampling. At time t6, switches pos_wtxx and neg_wtxx are turned off to decouple the pixels from Cout. At time t7, the row select and reset signals may be deasserted. At time t8, switch Acc2 is turned off.

At time t9, the Sub switch may be temporarily turned on to perform subtraction (e.g., to obtain the difference between the charge stored on Cout_pos and the charge stored on Cout_neg). At time t10, switch Acc1 is turned off while switch Act is turned on to apply Voffset. At time t11, switch Act may be turned off and at this point, Vneuron may be read out and captured.

For processing multiple rows sequentially, the precharge operation is performed only once on Cneuron, and the Cin capacitors are driven by the pixels with the SF_D node connected to supply voltage Vaa with switches pos_wtxx and neg_wtxx all shut off. Performing charge mode MAC operations using passive capacitors in this way in the analog domain for each layer of results in the neural network saves power and area by avoiding the need to move data around to the conventional digital memories.

FIG. 7D is a diagram showing how intermediate analog results may be temporarily stored in idle pixels in other parts of the pixel array. The pixels for storing intermediate results may therefore serve as analog memory, as opposed to processing the intermediate results using digital circuits in the digital domain. As shown in FIG. 7D, buffer 710 (see FIG. 7A) may drive output Vneuron onto analog storage. In addition to helping drive Vneuron, buffer 710 may provide the added functionality that clamps values less than zero volts to 0V or a common mode voltage to perform a non-linear “ReLU” operation on the intermediate result. Voltage Vneuron may be selectively coupled to a first idle pixel 400-C1′ via switch storage_result1, to a second idle pixel 400-B′ via switch storage_result2, and to a third idle pixel 400-A1 via switch storage_result3. Arranged in this way, voltage Vneuron may be stored on the temporarily idle or unused FD nodes of the pixel array, which are accessed via the respective RST_D path. This reset drain path may be shared with the power supply line that goes down to each pixel column. Groups of pixels with shared reset control may leverage capacitance Chold at reset drain node RST_D to hold analog value and then store the held voltage into each FD when all results are ready for storage. The stored intermediate analog results can be used for subsequent processing by an analog MAC processor. This analog storage portion may be a time multiplexed portion of the pixel array or may use ROI tiles that don't need to capture image data. Output voltage Vneuron stored in the analog domain in this way may be used when processing signals associated with different sets of weights, signals associated with different layers in a neural network, or may perform other types of recursive operations while avoiding having to access digital memory such as random-access memory on the bottom digital die. In other words, pixel values that are read out are not used for subsequent readout through an analog-to-digital converter but may instead be combine with additional weighted pixel values prior to being processed in the digital domain.

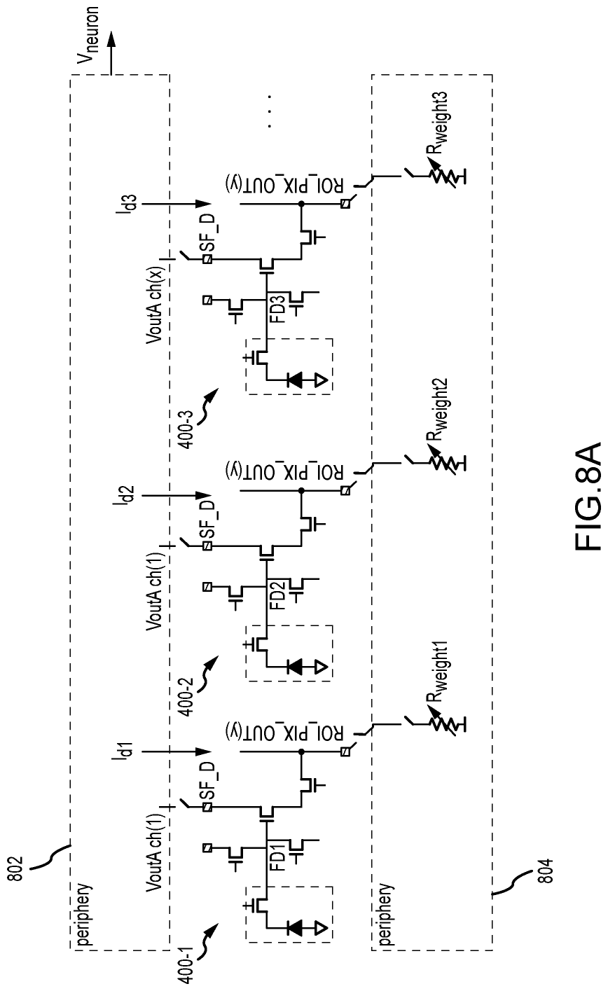

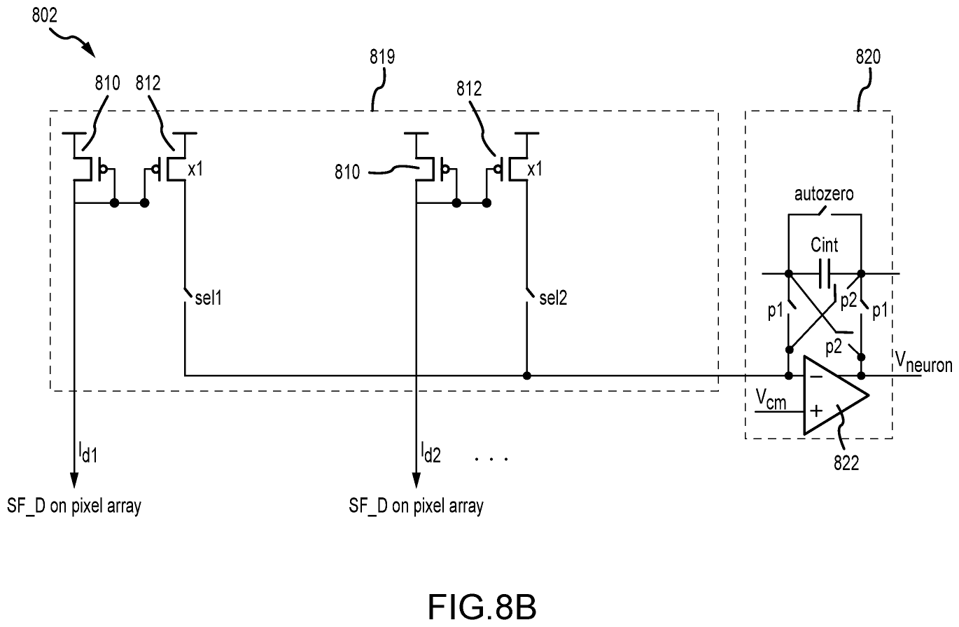

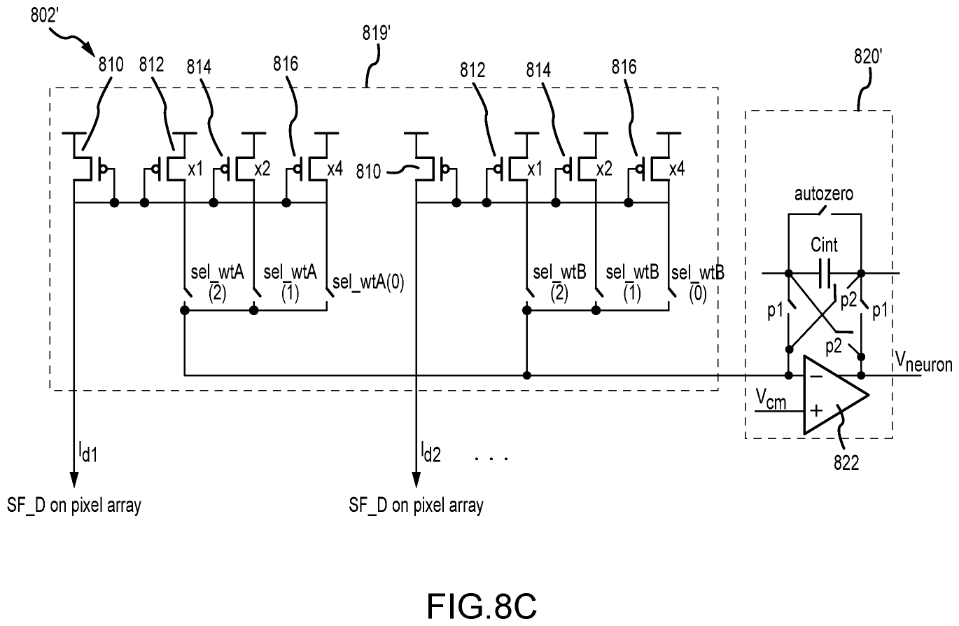

The passive charge mode feature extraction circuit described in connection with FIGS. 6-7 are merely illustrative and are not intended to limit the scope of the present embodiments. FIG. 8A is a diagram illustrating another suitable weighting scheme that uses adjustable resistors. As shown in FIG. 8A, the pixel output line of each pixel may be coupled to respective adjustable resistors (e.g., first pixel 400-1 may be coupled to a first resistive bank Rweight1, second pixel 400-2 may be coupled to a second resistive bank Rweight2, third pixel 400-3 may be coupled to a third resistive bank Rweight3, etc.). The value of these resistor banks may be statically or dynamically adjusted accordingly to the desired kernel weights.

The SF_D nodes may be coupled to a sum/difference current/charge integrator block 802 that generates output Vneuron. FIG. 8B illustrates one suitable implementation of integrator block 802. Block 802 may include a current minoring portion 819 and an integrator portion 820. The current minor circuitry 819 may include pull-up transistors 810 for sending the current onto the respective SF_D nodes in the pixel array, a first set of current minoring transistors 812 having a given size that is selectively coupled to integrator 820 via a corresponding select switch. The size of transistors 810 and 812 may be the same or may be different. Integrator block 820 may be implemented using a switched-capacitor scheme. Integrator 820 may include a comparator 822 having a first (+) input configured to receive common mode input voltage Vcm and a second (−) terminal coupled to the different current mirrored paths. A shared integrating capacitor Cint may be selectively cross-coupled across the input/output of amplifier 822 using switches p1 or p2 or may be reset using an auto-zeroing switch.

In accordance with another suitable arrangement, the resistive banks may alternatively be implemented as variable pulsed switches to control the total charge sink, a resistive non-volatile memory array of weights, or as virtual ground terminals with weights applied only in the current mirrors connected to the SF_D nodes (see, e.g., FIG. 8C using block 802′ while selectively shunting the local serial output buses to a virtual ground to provide the requisite current path). As shown in FIG. 8C, block 802 may include a current minor portion 819′ and an integrator portion 820′. The current mirror circuitry 819′ may include pull-up transistors 810 for sending the current onto the respective SF_D nodes in the pixel array, a first set of current mirroring transistors 812 having a given size that is selectively coupled to integrator 820 via switch sel_wtA(2), a second set of current minoring transistors 814 having 2× the given size that is selectively coupled to integrator 820 via switch sel_wtA(1), a third set of current minoring transistors 816 having 4× the given size that is selectively coupled to integrator 820 via switch sel_wtA(0), etc. The weights of each pixel column may be set by selecting one or more of the multiple current minor outputs (e.g., by configuring the various weighting switches). Integrator block 820′ may be implemented using a switched-capacitor scheme similar to that already described in connection with FIG. 8B and need not be reiterated in detail.

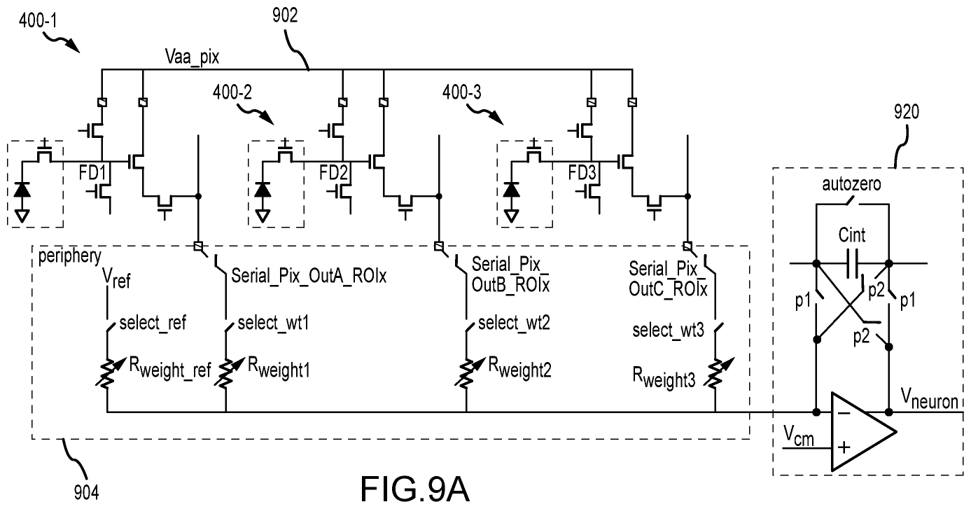

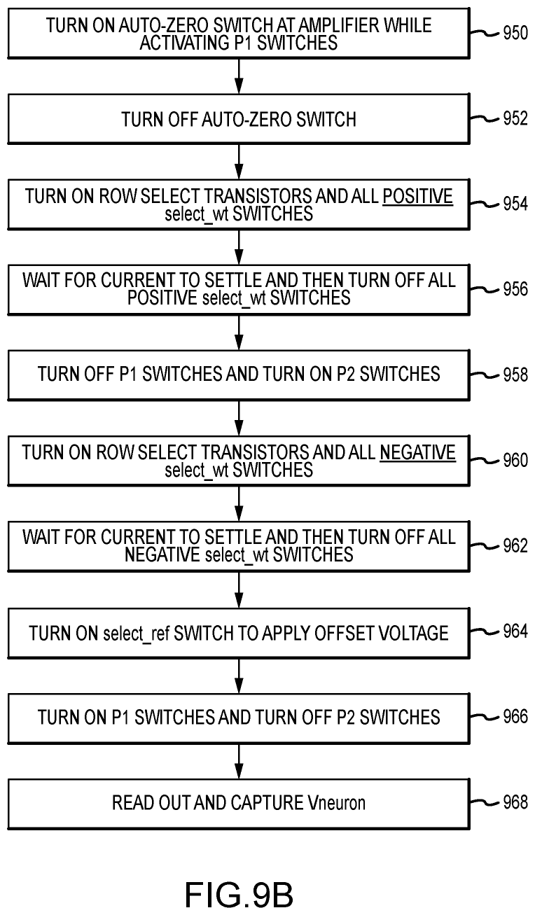

FIG. 9A is a diagram illustrating yet another suitable implementation of a charge mode feature extraction circuit. As shown in FIG. 9A, the RST_D and SF_D nodes may be coupled to power supply terminal 902 on which Vaa is provided, and the pixel output lines are coupled to the integrator block 920 via respective weighting resistors. Unlike the embodiments of FIG. 8A, 8B, and 8C, the embodiment of FIG. 9A has the integrator block 920 coupled to the pixel output line instead of the SF_D terminal. Integrator block 920 may have substantially the same structure as that already described in connection with FIG. 8B. In the example FIG. 9A, the column output line of pixel 400-1 is selectively coupled to the input of integrator 920 via switch select_wt1 and first adjustable resistive bank Rweight1; the column output line of pixel 400-2 is selectively coupled to the input of integrator 920 via switch select_wt2 and second adjustable resistive bank Rweight2; the column output line of pixel 400-3 is selectively coupled to the input of integrator 920 via switch select_wt3 and third adjustable resistive bank Rweight3; and so on. A reference voltage Vref (or some other offset voltage) may be selectively applied to the negative input of the integrator block 920 via a reference adjustable resistive bank Rweight_ref by turning on switch select_ref.

Illustrative steps for operating the circuitry of FIG. 9A is shown in FIG. 9B. At step 950, the auto-zero switch across the amplifier is turned on while the p1 switches are activated. During this time, the p2 switches are off and all weight select switches select_wtx are deactivated, which zeroes out the charge across capacitor Cint to ensure that the inputs of the comparator are both set at Vcm. At step 952, the auto-zero switch is turned off.

At step 954, the row select transistors and all the positive select_wt switches are turned on. At step 956, the pixel charge signal on the FD nodes associated with the positive weights will be accessed for a duration that would allow the integrating capacitor Cint to charge up to a level that is proportion to the FD voltages and the Rweight values. Thereafter, the positive select_wt switches are turned off.

At step 958, the p1 switches are turned off, whereas the p2 switches are turned on to flip the polarity of the integration capacitor Cint while temporarily halting the charging at Cint. At step 960, the row select transistors and all the negative select_wt switches are turned on. At step 962, the pixel charge signal on the FD nodes associated with the negative weights will be accessed for a duration that would allow the integrating capacitor Cint to charge up to a level that is proportion to the FD voltages and the Rweight values. Thereafter, the negative select_wt switches are turned off.

At step 964, the select_ref switch may be enabled for a duration that allows time for an offset voltage to be applied to Cint or that allows time for Cint to discharge by a subtract reference level that is proportional to the average dark level of all the pixel FD nodes and that is modulated by the Rweight values that is determined by the expected overall output current if the FD nodes were at the dark level. At step 966, the p1 switches are turned on again while the p2 switches are turned off. At step 968, final output voltage Vneuron may be read out and subsequently captured.

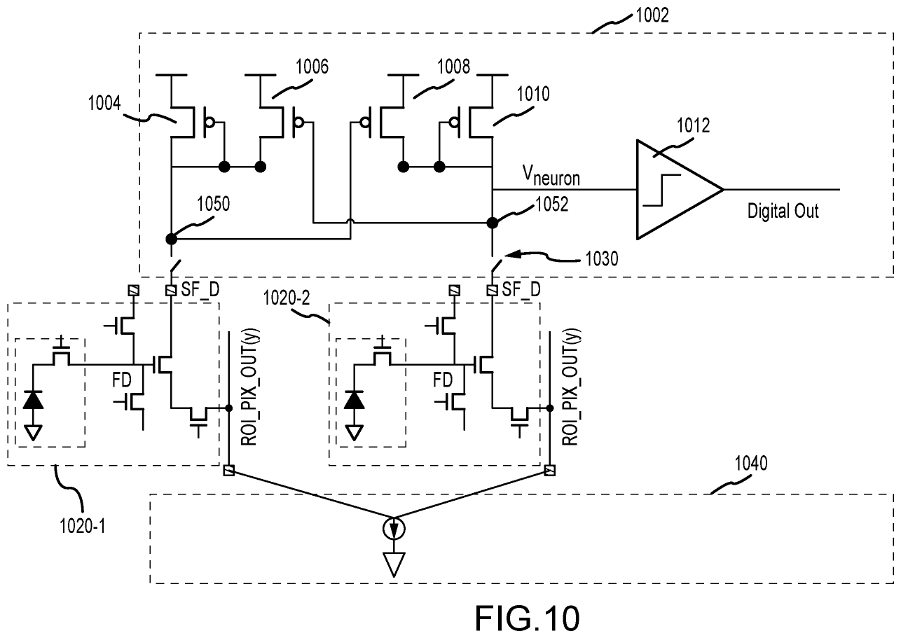

FIG. 10 is a diagram illustrating yet another suitable implementation of a charge mode feature extraction circuit that uses differential amplifier circuitry 1002 to compare the values between different groups of pixels. As shown in FIG. 10, the pixel column output lines of each pixel in the kernel window may be coupled to a shared current sink 1040 (which is sometimes considered part of the differential amplifier), a first group of pixels 1020-1 connected in parallel may have SF_D nodes coupled to a first node 1050 in the differential amplifier 1002 via a first switch matrix 1030, and a second group of pixels 1020-2 connected in parallel may have SF_D nodes coupled to a second node 1052 in the differential amplifier 1002 via a second switch matrix 1030.

Differential amplifier 1002 may further include a first diode-connected pull-up transistor connected to node 1050, a second diode-connected pull-up transistor 1010 connected to node 1052, a third pull-up transistor 1006 cross-coupled between nodes 1050 and 1052, a fourth pull-up transistor 1008 cross-coupled between nodes 1052 and 1050, and a comparator 1012 configured to receive voltage Vneuron from node 1052. Comparator 1012 may be configured to provide a digital output for a high speed ADC path. Configured in this way, differential amplifier 1002 may be used to output a binary digital value without any sort of weighting. Thus, if comparator 1012 outputs a “1”, the first group of pixels 1020-1 would have a greater pixel output value than the second group of pixels 1020-2. Conversely, if comparator outputs a “0”, the first group of pixels 1020-1 would have a lesser pixel output value than the second group of pixels 1020-2. If desired, the gate voltage of the row select signals in each individual pixel may be dynamically adjusted to control the weighting of analog kernel inputs.

The foregoing is merely illustrative of the principles of this invention and various modifications can be made by those skilled in the art without departing from the scope and spirit of the invention. The foregoing embodiments may be implemented individually or in any combination.

What is claimed is:

1. Imaging circuitry, comprising:
a first pixel configured to output a first pixel value;
a second pixel configured to output a second pixel value;
a first adjustable circuit configured to apply a first weighting factor to the first pixel value to generate a first weighted pixel value;
a second adjustable circuit configured to apply a second weighting factor to the second pixel value to generate a second weighted pixel value; and
an output circuit configured to combine the first weighted pixel value and the second weighted pixel value to generate an analog output voltage.

2. The imaging circuitry of claim 1, further comprising analog circuitry configured to store the analog output voltage in the analog domain.

3. The imaging circuitry of claim 1, wherein the first and second pixels are formed on a first die, and wherein the first and second adjustable circuits and the output circuit are formed on a second die stacked under the first die.

4. The imaging circuitry of claim 3, wherein the second die comprises:
local output buses configured to route the first and second pixel values to peripheral circuits on the second die.

5. The imaging circuitry of claim 4, wherein the second die comprises:
configurable buses that route source follower drain terminals in the first and second pixels to the peripheral circuits to generate and sum the first and second weighted values.

6. The imaging circuitry of claim 4, wherein the second die further comprises:
additional local output buses configured to support parallel generation and summing of the first and second weighted values.

7. The imaging circuitry of claim 3, wherein the first and second pixels are part of an array of image sensor pixels on the first die, and wherein the first pixel value is coupled to the second die via a global output bus that is configured to receive pixel values from other pixels in the array.

8. The imaging circuitry of claim 3, wherein the first and second pixels are part of an array of image sensor pixels, and wherein the first pixel value is coupled to the second die via a global output bus that is configured to receive pixel values from other pixels in only a subset of the array.

9. The imaging circuitry of claim 1, where the first pixel value is sensed multiple times at different weight levels by using a separate optically black reference pixel.

10. The imaging circuitry of claim 1, wherein the first pixel value is not used for subsequent readout through an analog-to-digital converter but is used only to combine with additional weighted pixel values.

11. The imaging circuitry of claim 1, wherein the first and second adjustable circuits comprise adjustable capacitor circuits.

12. The imaging circuitry of claim 11, wherein the output circuit comprises at least one output capacitor.

13. The imaging circuitry of claim 11, wherein the output circuit comprises a positive output capacitor configured to store charge associated with positive weighting factors and a second output capacitor configured to store charge associated with negative weighting factors.

14. The imaging circuitry of claim 1, wherein the first and second adjustable circuits comprise adjustable resistor circuits.

15. The imaging circuitry of claim 1, wherein the first and second adjustable circuits comprise adjustable current mirroring circuits.

16. The imaging circuitry of claim 1, wherein the first and second adjustable circuits comprise resistive non-volatile memory.

17. Imaging circuitry, comprising:
a first pixel having a first source follower drain terminal, wherein the first pixel is configured to output a first pixel value;
a second pixel having a second source follower drain terminal, wherein the second pixel is configured to output a second pixel value; and
current mirror circuitry having a first set of adjustable switches for applying a first weight to the first pixel value and a second set of adjustable switches for applying a second weight to the second pixel value.

18. The imaging circuitry of claim 17, wherein the first set of adjustable switches comprises switches of different sizes.

19. The imaging circuitry of claim 17, further comprising:
a switch capacitor based integrating circuit configured to receive signals from the current mirror circuitry.

20. Imaging circuitry, comprising:
a first group of active pixels configured to generate active pixel values;
weighting circuits configured to receive the active pixel values from the first group of active pixels and to generate corresponding weighted pixel values;
an output circuit configured to receive and combine the weighted pixel values to generate corresponding output voltages; and
a second group of idle pixels configured to temporarily store the output voltages to avoid having to store the output voltages in the digital domain.
